(19) United States
(12) Patent Application Publication
(10) Pub. No.: US 2014/0048203 A1
(43) Pub. Date: Feb. 20, 2014

(54) METHOD OF DISPOSING CATALYST IN REFORMER

(71) Applicants: Fan-Gang Tseng, New Taipei City (TW); Hsueh-Sheng Wang, Taichung City (TW)

(72) Inventors: Fan-Gang Tseng, New Taipei City (TW); Hsueh-Sheng Wang, Taichung City (TW)

(21) Appl. No.: 13/585,519

(22) Filed: Aug. 14, 2012

(51) Int. Cl. B32B 38/00

(52) U.S. Cl. 156/272.6; 156/280; 156/272.2

(57) ABSTRACT

A method of disposing catalyst in a reformer is disclosed. The method of disposing catalyst comprises the steps of providing a silicon-based substrate with a predetermined pattern thereon; providing a cover with an inlet hole and an outlet hole therein; bonding the silicon-based substrate with the cover; and disposing a catalyst solution on a wall of the predetermined pattern by centrifuging in a predetermined speed for a predetermined time so as to obtain a catalyst layer with a gradient-thickness on the wall.

### BACKGROUND OF THE INVENTION

1. Field of the Invention

The present invention generally relates to a method of disposing catalyst, in particular to a method of disposing catalyst in reformer.

2. Description of the Related Art

In recent years, the global warming and energy crisis have been an emerging issue around the world. For this reason, it's necessary to develop green, clean and renewable energies to solve such problems. In varieties of eco-friendly methods to create energies, fuel cells have emerged advantageously as alternative power sources owing to their high overall system efficiency and eco-friendly nature. For instance, one of the attractive applications is the use of the fuel cells in portable electronics so that the fuel cells are becoming striking alternatives to conventional lithium ion batteries.

There are mainly two types of small fuel cells can be used: direct methanol fuel cell (DMFC) and proton exchange membrane fuel cell (PEMFC). DMFC can be operated at lower temperature but supplies low power density. The low power density of DMFC is because of methanol crossover through the membrane and the low reaction rate of methanol oxidation at anodic catalyst. On the contrary, PEMFC, which requires gaseous H₂ as fuel, have higher power density than DMFC because of less fuel crossover at the membrane. Hence, a system with a stable supply of H₂ gas is prerequisite for the development of PEMFC. Accordingly, the ways of effectively coating catalysts in the channels of the reformer is crucial to the efficiency of the reformer.

Conventionally, slurry method is widely used in the art for the reason that few apparatuses, such as needles or brushes, are needed to coating catalysts in the channels of a reformer. Yet, the slurry method may only coat a thin layer of catalysts in the channel, and the thin layer of catalysts would not sufficiently react with the methanol to generate H₂ gas, which results in low efficiency of the reformer. Moreover, the distribution pattern of the catalyst in the channels affects the efficiency of the reformer as well. Conventionally, the distribution pattern of the catalysts is mostly circular shape, which may lead to non-uniform catalysts utilization. Thus, how to maximize the efficiency of the reformer and the amount of catalysts coated in the channel has become the major issue in the art.

### SUMMARY OF THE INVENTION

Therefore, it is a primary objective of the present invention to provide a method of disposing catalyst in a reformer to achieve the effect of increasing the gradient-thickness of catalysts in the channels and enhancing the H₂ gas generating efficiency of the reformer.

To achieve the foregoing objective, the present invention provides a method of disposing catalyst in a reformer comprising steps of providing a silicon-based substrate with a predetermined pattern thereon; providing a cover with an inlet hole and an outlet hole therein; bonding the silicon-based substrate with the cover; and disposing a catalyst solution on a wall of the predetermined pattern by centrifuging in a predetermined speed for a predetermined time so as to obtain a catalyst layer with a gradient-thickness on the wall.

Preferably, the gradient-thickness may be gradually thicker towards a centrifugal direction.

Preferably, the cover may comprise Pyrex glass.

Preferably, the silicon-based substrate may be bonded to the cover via anodic bonding.

Preferably, the predetermined pattern may be formed by photolithography and deep silicon reactive ion etching (DRIE) sequentially.

Preferably, the predetermined time may be between 1 to 10 minutes.

Preferably, the predetermined time may be further between 2 to 5 minutes.

Preferably, the predetermined speed may be between 1000 to 5000 rpm.

Preferably, the predetermined speed may be further between 1500 to 3000 rpm.

Preferably, a surface of the catalyst layer may be coarse and irregular.

Preferably, the method may further comprise a step of treating the predetermined pattern with an oxygen plasma so that the wall of the predetermined pattern is hydrophilic.

Preferably, the method may further comprise a step of drying the catalyst layer in an oven after disposing the catalyst solution on the wall.

Preferably, the method may further comprise repeating the steps of disposing the catalyst solution on the wall and drying the catalyst layer so as to increase the gradient-thickness of the catalyst layer.

Preferably, the catalyst solution may comprise a catalyst, distilled water and a binder.

Preferably, the catalyst may comprise copper, manganese and zinc.

Preferably, the binder may comprise boehmite and bentonite.

The method of disposing catalyst in a reformer according to the present invention adopt a centrifugation to obtain a catalyst layer with a gradient-thickness on a wall of the pattern, so that the present invention has the following advantages:

(1) The method of disposing catalyst in a reformer of the present invention can provide a catalyst layer with coarse and irregular surface so as to make the catalysts to react with methanol efficiently.

(2) The method of disposing catalyst in a reformer of the present invention can provide a catalyst layer with gradient-thickness so as to make the catalysts to react with methanol completely.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a flow chart of a method of disposing catalyst in a reformer in accordance with the present invention.

FIG. 2A is a schematic view of a method of disposing catalyst in a reformer in accordance with an embodiment of the present invention.

FIG. 2B is a configuration of a reformer to be centrifuged in accordance with an embodiment of the present invention.

FIG. 3 is a top view of a reformer in accordance with an embodiment of the present invention.

FIG. 4 is a schematic view of channels in the reformer in accordance with an embodiment of the present invention.

FIG. 5 is a schematic view of comparison of methanol conversion rate, hydrogen selectivity and hydrogen yield of the reformer in accordance with an embodiment of the present invention.

### DETAILED DESCRIPTION OF THE PREFERRED EMBODIMENTS

The technical content of the present invention will become apparent by the detailed description of the following embodiments and the illustration of related drawings as follows.

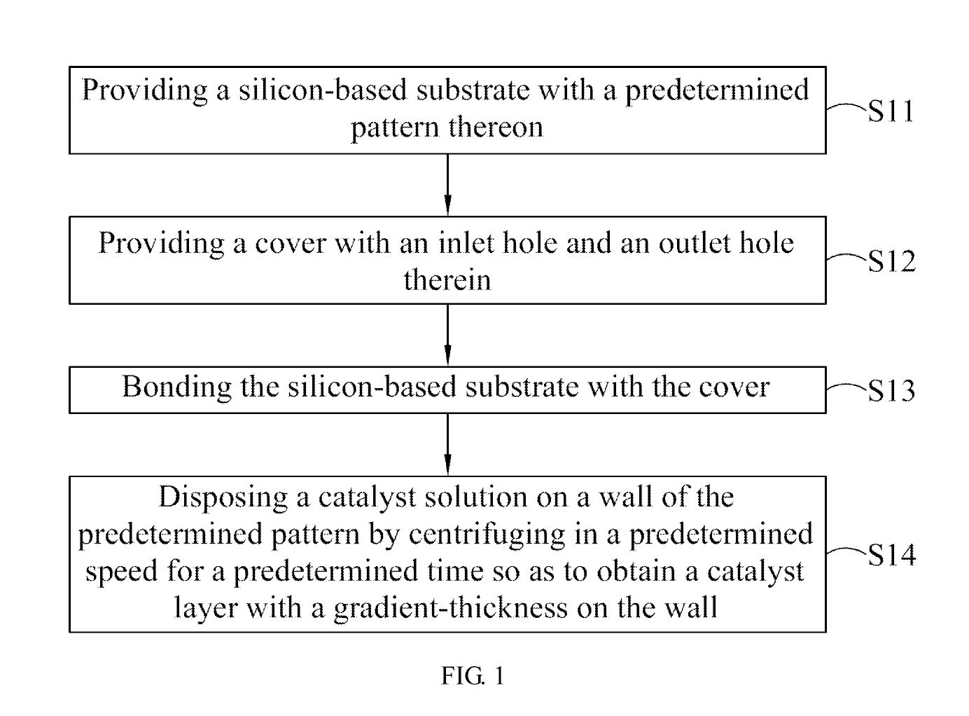

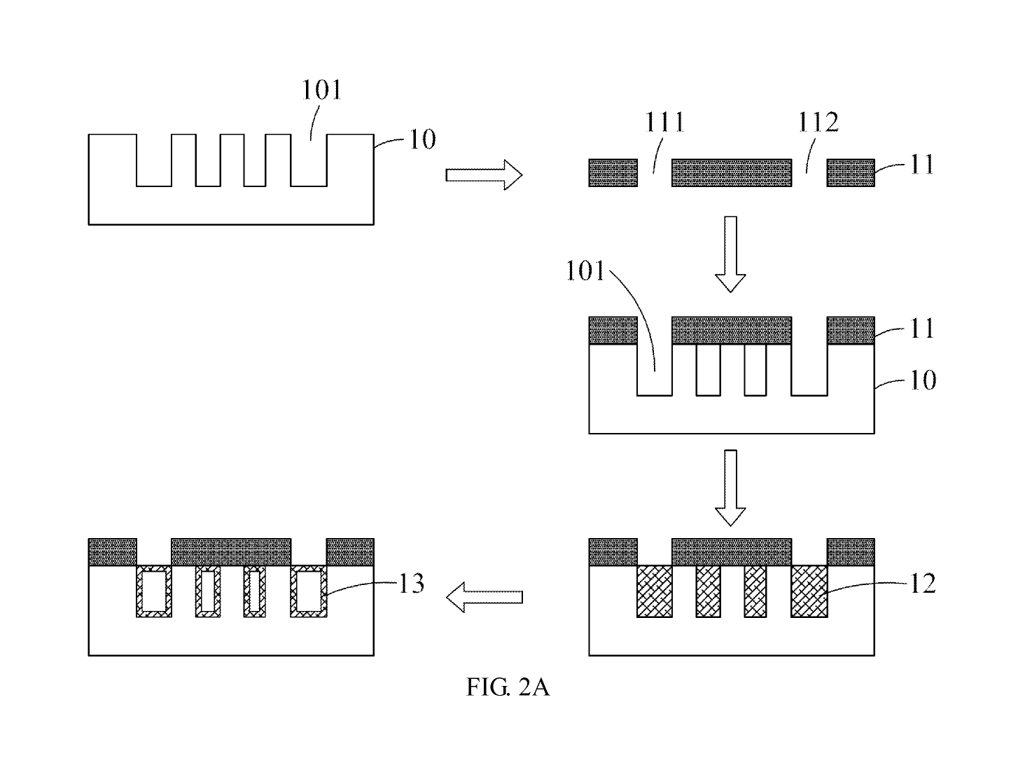

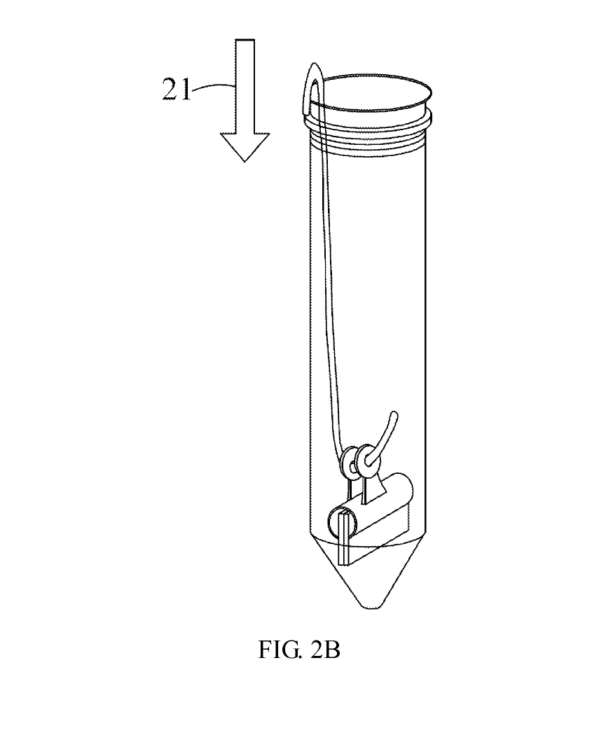

With reference to FIG. 1 and FIG. 2A, for a flow chart and a schematic view of a method of disposing catalyst in a reformer, respectively, in accordance with the present invention, the method of disposing catalyst in a reformer comprises steps of:

S11: providing a silicon-based substrate 10 with a predetermined pattern thereon;

S12: providing a cover 11 with an inlet hole 111 and an outlet hole 112 therein;

S13: bonding the silicon-based substrate 10 with the cover 11; and

S14: disposing a catalyst solution 12 on a wall of the predetermined pattern by centrifuging in a predetermined speed for a predetermined time so as to obtain a catalyst layer 13 with a gradient-thickness on the wall.

In a preferred embodiment, the gradient-thickness of the catalyst layer 13 is gradually thicker towards a centrifugal direction 21 as shown in FIG. 2B.

In a preferred embodiment, a silicon-based substrate 10 with a predetermined pattern formed by photolithography and deep silicon reactive ion etching (DRIE) sequentially was provided. Wherein, the silicon-based substrate 10 may be a silicon wafer. The pattern was designed and formed on a silicon wafer as channels 101 of a reformer by photolithography. Then, the silicon wafer with designed pattern was subjected to be etched by deep silicon reactive ion etching, forming channels 101 on the silicon wafer. In addition, the silicon wafer with channels 101 was subsequently treated with oxygen plasma so that the channels 101 would be hydrophilic.

In a preferred embodiment, a cover 11 comprising Pyrex glass was provided. The cover 11 comprising Pyrex glass was cut by LASER to form an inlet hole 111 and an outlet hole 112 in the cover 11. After that, the cover 11 with the inlet hole 111 and the outlet hole 112 was bonded to the silicon-based substrate 10 by anodic bonding, forming a prototype of reformer for the fuel cells. Nevertheless, the methods of bonding the cover 11 to the silicon-based substrate 10 may be varied and should not be construed as limited to the embodiments set forth herein.

Next, a catalyst solution 12 is prepared. Preferably, the catalyst solution 12 may contain well-mixed catalysts, H₂O and binders. In an embodiment, briefly, 10 mL H₂O was mixed with a constant content of a catalyst and a specific amount of binder, and well-mingled catalyst solution 12 was then mixed by stirring and sonicating for 1 hour so that the catalyst solution 12 may be obtained to be disposed in the channels 101. Wherein, the binders may comprise boehmite and bentonite, and the catalysts may comprise copper, manganese and zinc. The contents of the binders and the catalysts may be varied and should not be construed as limited to the embodiments set forth herein.

FIG. 2B demonstrates a configuration of a reformer to be centrifuged in accordance with an embodiment of the present invention. The mixed catalyst solution 12 was then injected into the channels 101 of the reformer. In addition, the reformer with the mixed catalyst solution 12 was subjected to be centrifuged in a predetermined speed for a predetermined time, disposing the catalyst solution 12 in the channels 101 to obtain a catalyst layer 13 with gradient-thickness. In an embodiment, the predetermined time may be between 1 to 10 minutes, and preferably between 2 to 5 minutes. The predetermined speed may be between 1000 to 5000 rpm, and preferably between 1500 to 3000 rpm. After centrifugation, the solvent in the catalyst solution 12 was dried out in an oven at 105° C. for 30 minutes. Preferably, the steps of disposing the catalyst solution 12 in the channels 101 and drying the catalyst layer 13 may be repeated for 10 times to increase the gradient-thickness of the catalyst layer 13 so as to enhancing the efficiency of the reformer. The times of repeating the steps may be varied and should not be construed as limited to the embodiments set forth herein. Finally, the reformer with gradient-thickness was obtained.

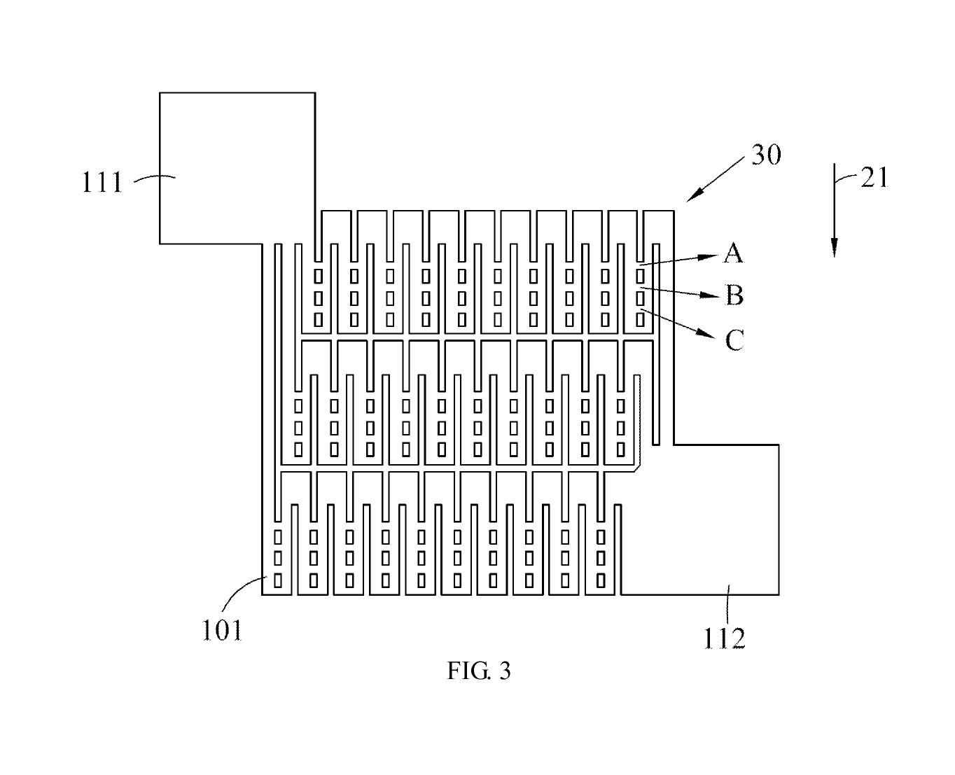

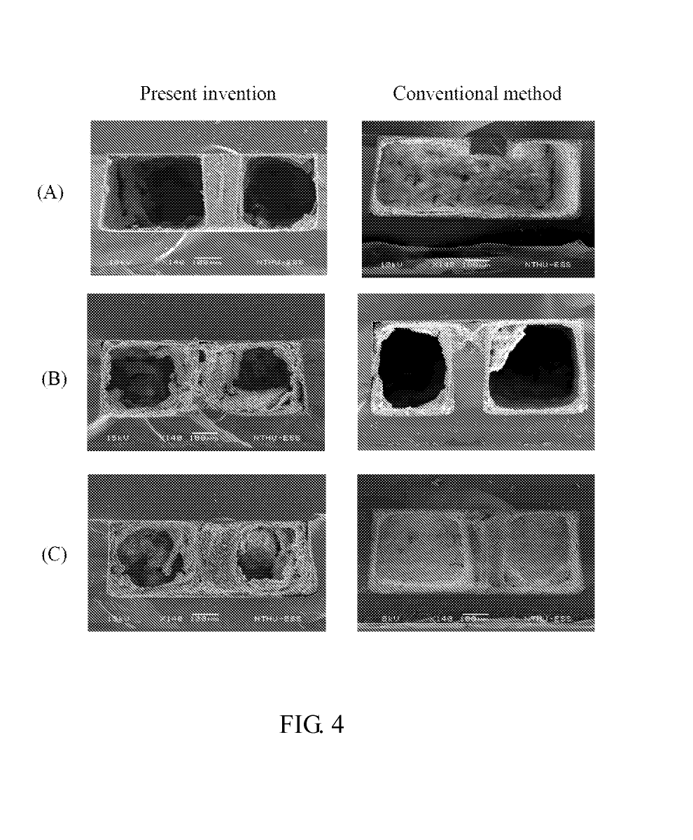

With reference to FIGS. 3 and 4 for a top view of a reformer and a schematic view of channels in the reformer in accordance with an embodiment of the present invention, respectively, the reformer 30 made by the method described in the present invention comprises an inlet hole 111 and an outlet hole 112 for input and output methanol, channels 101 for transform the methanol into hydrogen gas by the catalyst layer 13 therein. The alphabet A, B and C are the channels arranged towards the centrifugal direction 21. The cross-section views of the channels 101, such as A, B and C, were respectively imaged by scan electron microscope (SEM) and shown in FIG. 4. Referring to the FIG. 4, the catalyst layers in the channels 101 in accordance with present invention are gradually thicker from (A) to (C), centrifugal direction 21. Moreover, the surface of the catalyst layer 13 in accordance with the present invention is more coarse and irregular than that of the conventional method, which increases the react measure of the area that the catalyst layer 13 react with methanol. In this way, the methanol may sufficiently react with the catalyst layer 13 to maximize the hydrogen gas generation in the reformer 30.

In the following, the efficiency of the reformers in accordance with present invention and conventional method will be compared with each other. Firstly, the reformer was disposed on the hotplate to be heated to the required temperature for testing. Afterward, reactive gaseous were sent in the inlet hole of the reformer in the flow rate of 2 (mL/min) via mass flow controller to transform methanol into hydrogen gas, accompanying with some of carbon dioxide, carbon monoxide and water. Then, the variety of gas would be analyzed through gas chromatography (GC) to indentify the performance of reformer.

The methanol conversion rate (COV. %), hydrogen selectivity (S_{H2}) were calculated via the following Eq.(1) and Eq. (2), respectively:

$$COV . \% = \frac{n 1 - n 2}{n 1} \times 100 \% \qquad ( 1 )$$

wherein, n1: nMeOHᵢₙ; n2: nMeOHₒᵤₜ

$${S}_{{H}_{2}} = \frac{{n H}_{2}}{{n H}_{2} + {n H}_{2} O} \times 100 \% \qquad ( 2 )$$

wherein, n1 is the amount of steam methanol sent into the reformer, n2 is the remained amount of steam methanol that was used, nH₂ and nH₂O are the amount of the generated hydrogen and water gas, respectively.

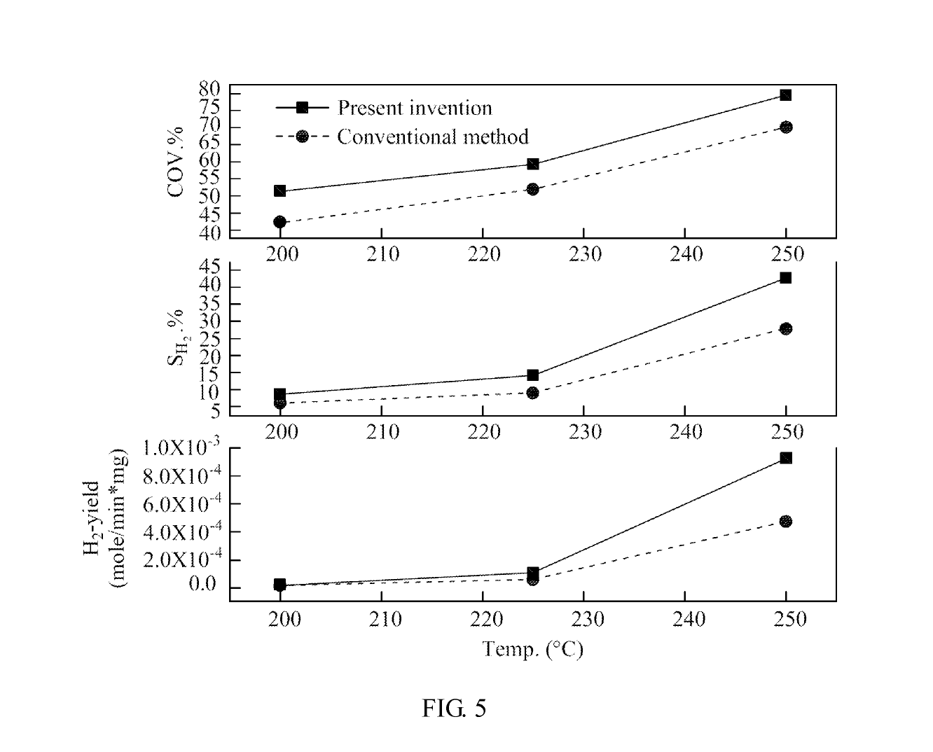

With reference to FIG. 5 for a schematic view of comparison of methanol conversion rate, hydrogen selectivity and hydrogen yield of the reformer in accordance with an embodiment of the present invention, the square and circle indicate the reformer made of the method in accordance with the present invention or with the conventional method, respectively. Indeed, either the methanol conversion rate or hydrogen selectivity is higher in the reformer in accordance with the present invention. Considering the amount of catalyst disposed, the hydrogen yield is till higher in the reformer in accordance with the present invention rather than with the conventional method. On the other hand, the methanol conversion rate, the hydrogen selectivity and the hydrogen yield are all gradually becoming higher as the increasing reaction temperature. Especially in 250° C. of reaction temperature, the methanol conversion rate, the hydrogen selectivity and the hydrogen yield are significantly higher.

In summation of the description above, the method of disposing catalyst in a reformer by a centrifugation process according to the present invention provides a catalyst layer with gradient-thickness, and coarse and irregular surface, so as to increase reaction area between catalysts and methanol. Thus, the methanol may sufficiently and completely react with the catalyst layer in the reformer to generate hydrogen gas, and the methanol conversion rate, the hydrogen selectivity and the hydrogen yield would be maximized so as to be stable and reliable hydrogen source for the fuel cells.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A method of disposing catalyst in a reformer:
providing a silicon-based substrate with a predetermined pattern thereon;
providing a cover with an inlet hole and an outlet hole therein;
bonding the silicon-based substrate with the cover; and
disposing a catalyst solution on a wall of the predetermined pattern by centrifuging in a predetermined speed for a predetermined time so as to obtain a catalyst layer with a gradient-thickness on the wall.

2. The method of claim 1, wherein the gradient-thickness is gradually thicker towards a centrifugal direction.

3. The method of claim 1, wherein the cover comprises Pyrex glass.

4. The method of claim 3, wherein the silicon-based substrate is bonded to the cover via anodic bonding.

5. The method of claim 1, wherein the predetermined pattern is formed by photolithography and deep silicon reactive ion etching (DRIE) sequentially.

6. The method of claim 1, wherein the predetermined time is between 1 to 10 minutes.

7. The method of claim 6, wherein the predetermined time is further between 2 to 5 minutes.

8. The method of claim 1, wherein the predetermined speed is between 1000 to 5000 rpm.

9. The method of claim 8, wherein the predetermined speed is further between 1500 to 3000 rpm.

10. The method of claim 1, wherein a surface of the catalyst layer is coarse and irregular.

11. The method of claim 1, further comprising a step of treating the predetermined pattern with an oxygen plasma so that the wall of the predetermined pattern is hydrophilic.

12. The method of claim 1, further comprising a step of drying the catalyst layer in an oven after disposing the catalyst solution on the wall.

13. The method of claim 12, further comprising repeating the steps of disposing the catalyst solution on the wall and drying the catalyst layer so as to increase the gradient-thickness of the catalyst layer.

14. The method of claim 1, wherein the catalyst solution comprises a catalyst, distilled water and a binder.

15. The method of claim 14, wherein the catalyst comprises copper, manganese and zinc.

16. The method of claim 14, wherein the binder comprises boehmite and bentonite.
